(19) United States
(12) Patent Application Publication
(10) Pub. No.: US 2026/0155133 A1
(43) Pub. Date: Jun. 4, 2026

(54) SYSTEMS AND METHODS FOR GENERATING SPEECH WITH INTONATION VARIETY USING MACHINE LEARNING

(71) Applicants: Constructor Technology AG, Schaffhausen (CH); Constructor Education and Research Genossenschaft, Schaffhausen (CH)

(72) Inventors: Sergey ULASEN, Singapore (SG); Andrey ADASCHIK, Istanbul (TR); Marcel de KORTE, Stockholm (SE); Dmitry OBUKHOV, Castelló de la Plana (ES); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/964,841

(22) Filed: Dec. 2, 2024

(51) Int. Cl. G10L 13/027; G10L 13/06; G10L 13/10

(52) U.S. Cl. CPC G10L 13/027; G10L 13/06; G10L 13/10

(57) ABSTRACT

Disclosed herein are systems and method for executing a text-to-speech machine learning model. A method includes: determining a first phoneme embedding from an input phoneme sequence; determining, using a text embedding model, a token-level embedding from an input word sequence, wherein the input phoneme sequence corresponds to the input word sequence; upsampling the token-level embedding into a second phoneme embedding; inputting both the first phoneme embedding and the second phoneme embedding in an encoder-decoder machine learning model configured to generate acoustic features for a vocoder model that produces a speech waveform; and executing the vocoder model to generate speech reciting the input word sequence.

### FIELD OF TECHNOLOGY

The present disclosure relates to the field of text-to-speech conversion, and, more specifically, to systems and methods for generating speech with intonation variety using machine learning.

### BACKGROUND

Modern text-to-speech models have become highly intelligible and natural, but in many cases, still lack appropriate intonational variation. This is caused by the fact that the input representation made up of phonemes only learns correct pronunciations and local variations in intonation, but lacks the ability to understand the syntactic and semantic patterns that characterize human intonation.

### SUMMARY

The present disclosure addresses the shortcomings of existing text-to-speech models with the introduction of a language model that produces word embeddings. Because these language models are trained on large amounts of data, they are able to learn syntactic and semantic patterns in different parts of the network. By extracting information from different layers of the network, the systems and methods of the present disclosure obtain a representation that captures semantic and syntactic information with high quality. These word embedding representations are then expanded (upsampled) to match the dimensions of the phoneme representation and add the two together. The result is a model that produces synthetic speech with a much richer and more appropriate intonation variety.

In one exemplary aspect, the techniques described herein relate to a method for executing a text-to-speech machine learning model, the method including: determining a first phoneme embedding from an input phoneme sequence; determining, using a text embedding model, a token-level embedding from an input word sequence, wherein the input phoneme sequence corresponds to the input word sequence; upsampling the token-level embedding into a second phoneme embedding; inputting both the first phoneme embedding and the second phoneme embedding in an encoder-decoder machine learning model configured to generate acoustic features for a vocoder model that produces a speech waveform; and executing the vocoder model to generate speech reciting the input word sequence.

In some aspects, the techniques described herein relate to a method, wherein the text embedding model is a transformer-based text embedding model such as Robustly optimized BERT approach (RoBERTa) model or BERT model.

In some aspects, the techniques described herein relate to a method, further including: determining a speaker embedding based on an input speaker identifier; and inputting the speaker embedding into the encoder-decoder machine learning model, wherein a voice associated with the speech generated by the vocoder model is of a speaker associated with the input speaker identifier.

In some aspects, the techniques described herein relate to a method, wherein the encoder-decoder machine learning model is integrated with a prosody conditioning network (PCN).

In some aspects, the techniques described herein relate to a method, wherein the PCN extracts prosodic features from the input word sequence, further including: integrating an output latent representation of an encoder in the encoder-decoder machine learning model with the prosodic features; and inputting the integrated output latent representation into a decoder of the encoder-decoder machine learning model to generate the acoustic features.

In some aspects, the techniques described herein relate to a method, wherein integration of the output latent representation with the prosodic features is performed using one or more of: concatenation, addition, a fusion function.

In some aspects, the techniques described herein relate to a method, wherein the prosodic features include one or more of: pitch, duration, and energy.

In some aspects, the techniques described herein relate to a method, wherein the acoustic features are included in a Mel spectrogram or self-supervised learning features.

In some aspects, the techniques described herein relate to a system for executing a text-to-speech machine learning model, including: at least one memory; and at least one hardware processor coupled with the at least one memory and configured, individually or in combination, to: determine a first phoneme embedding from an input phoneme sequence; determine, using a text embedding model, a token-level embedding from an input word sequence, wherein the input phoneme sequence corresponds to the input word sequence; upsample the token-level embedding into a second phoneme embedding; input both the first phoneme embedding and the second phoneme embedding in an encoder-decoder machine learning model configured to generate acoustic features for a vocoder model that produces a speech waveform; and execute the vocoder model to generate speech reciting the input word sequence.

In some aspects, the techniques described herein relate to a system, wherein the text embedding model is a Robustly optimized BERT approach (RoBERTa) model.

In some aspects, the techniques described herein relate to a system, wherein the at least one hardware processor is further configured to: determine a speaker embedding based on an input speaker identifier; and input the speaker embedding into the encoder-decoder machine learning model, wherein a voice associated with the speech generated by the vocoder model is of a speaker associated with the input speaker identifier.

In some aspects, the techniques described herein relate to a system, wherein the encoder-decoder machine learning model is integrated with a prosody conditioning network (PCN).

In some aspects, the techniques described herein relate to a system, wherein the PCN extracts prosodic features from the input word sequence, wherein the at least one hardware processor is further configured to: integrate an output latent representation of an encoder in the encoder-decoder machine learning model with the prosodic features; and input the integrated output latent representation into a decoder of the encoder-decoder machine learning model to generate the acoustic features.

In some aspects, the techniques described herein relate to a system, wherein integration of the output latent representation with the prosodic features is performed using one or more of: concatenation, addition, a fusion function.

In some aspects, the techniques described herein relate to a system, wherein the prosodic features include one or more of: pitch, duration, and energy.

In some aspects, the techniques described herein relate to a system, wherein the acoustic features are included in a Mel spectrogram or self-supervised learning features.

In some aspects, the techniques described herein relate to a non-transitory computer readable medium storing thereon computer executable instructions for executing a text-to-speech machine learning model, including instructions for: determining a first phoneme embedding from an input phoneme sequence; determining, using a text embedding model, a token-level embedding from an input word sequence, wherein the input phoneme sequence corresponds to the input word sequence; upsampling the token-level embedding into a second phoneme embedding; inputting both the first phoneme embedding and the second phoneme embedding in an encoder-decoder machine learning model configured to generate acoustic features for a vocoder model that produces a speech waveform; and executing the vocoder model to generate speech reciting the input word sequence.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating speech with intonation variety using machine learning.

FIG. 2 illustrates a flow diagram of a method for speech generation using latent features extracted from intermediate layers of an acoustic model.

FIG. 3 presents an example of a general-purpose computer system on which aspects of the present disclosure can be implemented.

### DETAILED DESCRIPTION

Exemplary aspects are described herein in the context of a system, method, and computer program product for generating speech with intonation variety using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

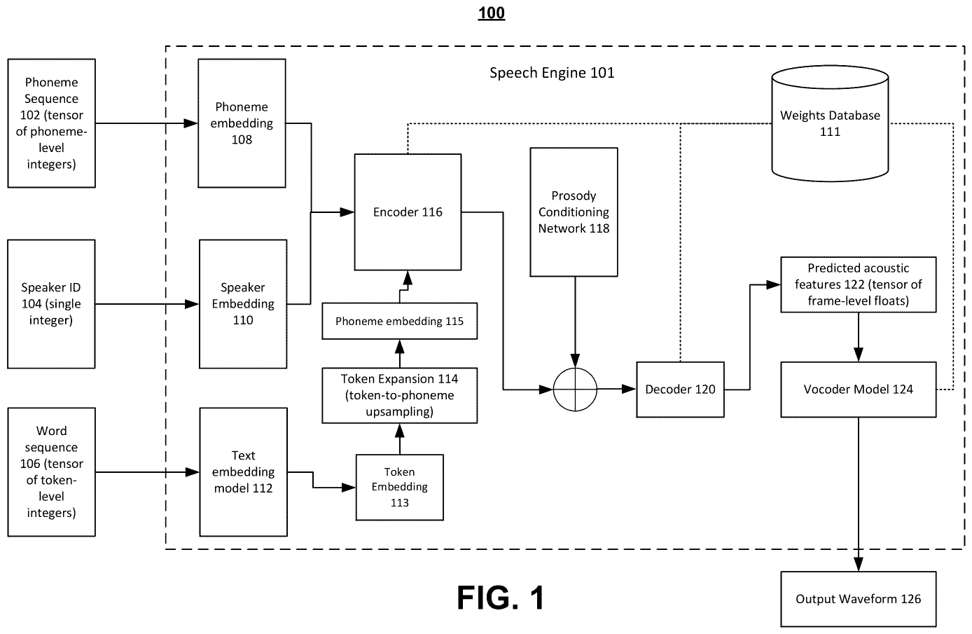

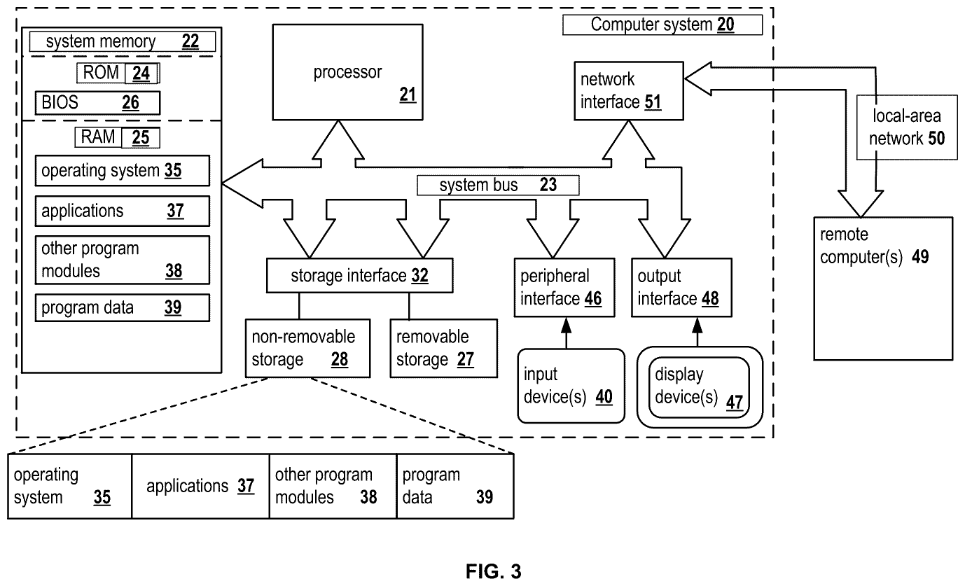

FIG. 1 is a block diagram illustrating a system 100 for generating speech with intonation variety using machine learning. System 100 includes speech engine 101, which is a software-based audio model pipeline that may be executed by a computer system 20 (e.g., described in FIG. 3). Speech engine 101 may first generate phonemes embeddings using a language model. Phoneme sequence 102 is a tensor of phoneme-level integers.

Speaker identifier (ID) 104 (e.g., a single integer) represents a particular speaker whose voice needs to be used to generate speech. Speaker ID 104 is associated with a plurality of weights that are learned when training the machine learning models of speech engine 101. Speech engine 101 may store weights and speaker IDs in weights database 111. Accordingly, for an input speaker ID, the corresponding learned weights are loaded from weights database 111 into the machine learning models to produce a waveform representing text being recited in the voice associated with the particular speaker ID.

Word sequence 106 represents a tensor of token-level integers. Consider an example in which word sequence 106 represents the phrase “we are happy.” The corresponding phoneme sequence 102 (using a phonemic transcription system such as ARPAbet) thus represents “W IY AA R HH AE P IY.”

System 100 then determines phoneme embedding 108 and speaker embedding 110 based on phoneme sequence 102 and speaker ID 104, respectively. Phoneme embedding 108 is a numerical representation of phonemes that capture their phonetic properties and relationships in a continuous vector space.

To generate phoneme embeddings for the sequence “we are happy,” for example, in some aspects, system 100 may use a pre-trained phoneme embedding model to map each phoneme to its corresponding embedding vector. In an exemplary aspect, phoneme embedding 108 is a trainable embedding. That is, when updating model weights, the phoneme embeddings are also updated.

A hypothetical example of phoneme embedding 108 is shown below.
   |Phoneme|Embedding (Example)|
   |---------|----------------------|
   |W|[0.12, −0.34, 0.56, . . . , 0.78]|
   |IY|[0.45, −0.67, 0.89, . . . , 0.12]|
   |AA|[0.23, −0.45, 0.67, . . . , 0.34]|
   |R|[0.56, −0.78, 0.12, . . . , 0.45]|
   |HH|[0.34, −0.56, 0.78, . . . , 0.67]|
   |AE|[0.67, −0.89 , 0.23, . . . , 0.78]|
   |P|[0.78, −0.12, 0.34, . . . , 0.89]|

In this matrix, each row corresponds to the embedding of a phoneme. For example, if each phoneme embedding is a 256-dimensional vector, the resulting matrix for the sequence would be of size (8*256). In some aspects, the phoneme embedding model may be TensorFlowTTS (a library that provides pre-trained models for text-to-speech synthesis) or ESPnet (an end-to-end speech processing toolkit that includes models for speech recognition and synthesis).

Text embedding model 112 is configured to generate token-level embeddings 113. For example, text embedding model 112 may be a Robustly optimized BERT approach (RoBERTa) model. Word embeddings from text embedding model 112 are high-dimensional vectors that represent the semantic meaning of words in a continuous vector space. These embeddings capture the context and relationships between words, allowing the model to understand and generate human-like text.

RoBERTa, for example, is a transformer-based model that builds on BERT (Bidirectional Encoder Representations from Transformers) by optimizing the training process and using more data. The embeddings generated by text embedding model 112 are context-dependent, meaning that the same word can have different embeddings depending on its context in a sentence.

Consider the sentence “we are happy.” Text embedding model 112 generates embeddings for each word in this sentence using the following steps:
Tokenization: The sentence is tokenized into subwords or tokens.

Embedding Extraction: The model processes the tokens and generates embeddings for each token.

Contextualization: The embeddings are context-dependent, meaning they capture the meaning of each word in the context of the entire sentence.

In an example, the sentence “we are happy” is tokenized into tokens. For example, RoBERTa uses a byte-pair encoding (BPE) tokenizer to generate: Tokens: ‘<s>’, ‘We’, ‘are’, ‘happy’, ‘</s>’

Here, ‘<s>’ is a special token added at the beginning of the sentence, and ‘</s>’ is a special token added at the end.

The model 112 then generates embeddings for each token. These embeddings are high-dimensional vectors with a hypothetical example being:
   |Token|Embedding (Example)|
   |--------|------------------------------------|
   |<s>|[0.12, −0.34, 0.56, . . . , 0.78]|
   |We|[0.45, −0.67, 0.89, . . . , 0.12]|
   |are|[0.23, −0.45, 0.67, . . . , 0.34]|
   |happy|[0.56, −0.78, 0.12, . . . , 0.45]|
   |</s>|[0.34, −0.56, 0.78, . . . , 0.67]|
Here, each embedding is a vector of fixed size (e.g., 768 dimensions for RoBERTa-base). These vectors capture the semantic meaning of the tokens in the context of the sentence.

The token-level embeddings 115 produced are then upsampled by system 100 during token expansion 114. More specifically, a token to phoneme upsample is performed. Suppose that this results in the following matrix:
   |Phoneme |Embedding (Example) |
   |---------|------------------------------------|
   |<s>|[0.12, −0.34, 0.56, . . . , 0.78]|
   |/w/|[0.45, −0.67, 0.89, . . . , 0.12]|
   |/iy/|[0.45, −0.67, 0.89 , . . . , 0.12]|
   |/aa/|[0.23, −0.45, 0.67, . . . , 0.34]|
   |/r/|[0.23, −0.45, 0.67, . . . , 0.34]|
   |/hh/|[0.56, −0.78, 0.12, . . . , 0.45]|
   |/ae/|[0.56, −0.78, 0.12, . . . , 0.45]|
   |/p/|[0.56, −0.78, 0.12, . . . , 0.45]|
   |/iy/|[0.56, −0.78, 0.12, . . . , 0.45]|
   |</s>|[0.34, −0.56, 0.78, . . . , 0.67]|
In this example, each of the tokens are converted into their corresponding phoneme. The vector associated with the particular token is then duplicated. For example, “we” is mapped to [0.45, −0.67, 0.89, . . . , 0.12]. When expanded, “w” and “iy” are also mapped to [0.45, −0.67, 0.89, . . . , 0.12]. The phoneme embedding 115, phoneme embedding 108, and speaker embedding 110 are input into an encoder-decoder model comprising encoder 116 and decoder 120.

Encoder 116 processes the input sequences and compresses them into a fixed-size context vectors (also known as the hidden state or latent representation). In some aspects, encoder 116 includes layers of recurrent neural networks (RNNs), long short-term memory networks (LSTMs), gated recurrent units (GRUs), or transformer layers. Each embedding is processed/integrated in encoder 116 by the addition of tensors representing the embeddings.

Decoder 120 takes the context vectors from encoder 116 and generates predicted acoustic features 122 (e.g., a tensor of frame-level floats) such as a Mel spectrogram. In some aspects, decoder 120 comprises layers of RNNs, LSTMs, GRUs, or transformer layers. The output of decoder 120 may be input into a vocoder model 124 to generate output waveform 126 (e.g., speech).

In some aspects, a Prosody Conditioning Network (PCN) 118 is integrated with encoder 116 to enhance the generation of acoustic features by incorporating prosodic information (e.g., pitch, duration, and energy) into the synthesis process. This integration helps produce more natural and expressive speech. For example, PCN 118 may extract prosodic features from the input text. PCN 118 further takes the prosodic features and integrates them with the latent representation from encoder 116. This can be done through concatenation, addition, or a more complex fusion mechanism. Decoder 120 then takes the conditioned latent representation and generates the acoustic features 122, such as a mel spectrogram.

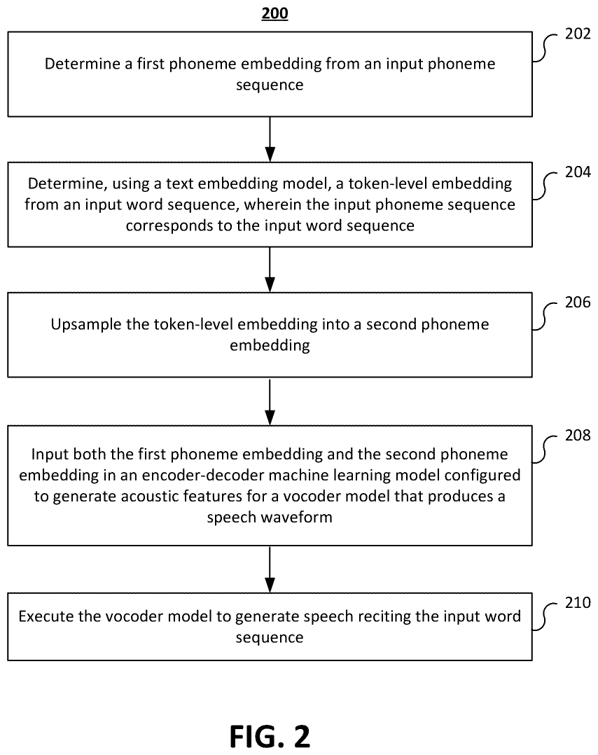

FIG. 2 illustrates a flow diagram of method 200 for speech generation using latent features extracted from intermediate layers of an acoustic model.

At 202, speech engine 101 determines a first phoneme embedding 108 from an input phoneme sequence 102. For example, embedding 108 for the phoneme sequence associated with the text “we are happy” may be:
   |Phoneme |Embedding (Example) |
   |---------|----------------------|
   |W|[0.12, −0.34, 0.56, . . . , 0.78]|
   |IY|[0.45, −0.67, 0.89, . . . , 0.12]|
   |AA|[0.23, −0.45, 0.67, . . . , 0.34]|
   |R|[0.56, −0.78, 0.12, . . . , 0.45]|
   |HH|[0.34, −0.56, 0.78, . . . , 0.67]|
   |AE|[0.67, −0.89, 0.23, . . . , 0.78]|
   |P|[0.78, −0.12, 0.34, . . . , 0.89]|
At 204, speech engine 101 determines, using a text embedding model 112, a token-level embedding 113 from an input word sequence 106. In some aspects, the text embedding model is a Robustly optimized BERT approach (RoBERTa) model. Here, the input phoneme sequence 102 corresponds to the input word sequence 106. Suppose that token-level embedding 113 is:
         |Token |Embedding (Example) |
   |--------|------------------------------------|
   |<s>|[0.12, −0.34, 0.56, . . . , 0.78]|
   |We|[0.45, −0.67, 0.89, . . . , 0.12]|
   |are|[0.23, −0.45, 0.67, . . . , 0.34]|
   |happy|[0.56, −0.78, 0.12, . . . , 0.45]|
   |</s>|[0.34, −0.56, 0.78, . . . , 0.67]|

At 206, speech engine 101 upsamples (e.g., token expansion 114) the token-level embedding into a second phoneme embedding 115 such as:
   |Phoneme |Embedding (Example) |
   |---------|------------------------------------|
   |<s>|[0.12, −0.34, 0.56, . . . , 0.78]|
   |/w/|[0.45, −0.67, 0.89, . . . , 0.12]|
   |/iy/|[0.45, −0.67, 0.89, . . . , 0.12]|
   |/aa/|[0.23, −0.45, 0.67, . . . , 0.34]|
   |/r/|[0.23, −0.45, 0.67, . . . , 0.34]|
   |/hh/|[0.56, −0.78, 0.12, . . . , 0.45]|
   |/ae/|[0.56, −0.78, 0.12, . . . , 0.45]|
   |/p/|[0.56, −0.78, 0.12, . . . , 0.45]|
   |/iy/|[0.56, −0.78, 0.12, . . . , 0.45]|
   |</s>|[0.34, −0.56, 0.78, . . . , 0.67]|

At 208, speech engine 101 inputs both the first phoneme embedding 108 and the second phoneme embedding 113 in an encoder-decoder machine learning model (comprising encoder 116 and decoder 120) configured to generate acoustic features 122 for a vocoder model 124 that produces a speech waveform 126. The encoder processes the input phoneme embeddings to generate a sequence of hidden states (latent representations). These hidden states capture the contextual information of the input sequence. The decoder takes the latent representations (possibly integrated with prosodic features) and generates the output acoustic features. These features represent the characteristics of the synthesized speech.

In some aspects, the acoustic features 122 are comprised in a Mel spectrogram or self-supervised learning features. A Mel-spectrogram is a 2D array where the x-axis represents time frames, the y-axis represents Mel frequency bins, and the values in the array represent the intensity (amplitude) of the frequency components.

Here is a simplified example of acoustic features 122:
Time Frames→
Frequency Bins↓
[0.1, 0.2, 0.3, . . . , 0.4]
[0.5, 0.6, 0.7, . . . , 0.8]
[0.9, 1.0, 1.1, . . . , 1.2]
. . .
[0.3, 0.4, 0.5, . . . , 0.6]

In some aspects, speech engine 101 further determines a speaker embedding 110 based on an input speaker identifier 104. Accordingly, speech engine 101 inputs the speaker embedding 110 into the encoder-decoder machine learning model, wherein a voice associated with the speech generated by the vocoder model 124 is of a speaker associated with the input speaker identifier 104.

In some aspects, the encoder-decoder machine learning model is integrated with a prosody conditioning network (PCN) 118 that extracts prosodic features (e.g., one or more of: pitch, duration, and energy) from the input word sequence 106. Accordingly, speech engine 101 integrates an output latent representation of an encoder 116 in the encoder-decoder machine learning model with the prosodic features, and inputs the integrated output latent representation into a decoder 120 of the encoder-decoder machine learning model to generate the acoustic features 122. In some aspects, the integration of the output latent representation with the prosodic features is performed using one or more of: concatenation, addition, a fusion function.

PCN 118 is responsible for extracting prosodic features from the input word sequence. Prosodic features include, for example, (1) pitch, which is the perceived frequency of the sound and can convey intonation and stress, (2) duration, which is the length of time each phoneme or word is spoken, and (3) energy, which is the loudness or intensity of the speech. Suppose again that the input word sequence is “we are happy.” The prosodic features identified by PCN 118 for each phoneme may be:
/w/: Pitch=120 Hz, Duration=20 ms, Energy=0.8
/iy/: Pitch=110 Hz, Duration=30 ms, Energy=0.7
/aa/: Pitch=115 Hz, Duration=35 ms, Energy =0.75
/r/: Pitch=125 Hz, Duration=125 ms, Energy=0.85
/hh/: Pitch=130 Hz, Duration=50 ms, Energy=0.9
/ae/: Pitch=135 Hz, Duration=60 ms, Energy=0.95
/p/: Pitch=140 Hz, Duration=40 ms, Energy=1.0
/iy/: Pitch=145 Hz, Duration=45 ms, Energy=1.05
The vector representation may thus be:
   |/w/|[120, 20, 0.8]|
   |/iy/|[110, 30, 0.7]|
   |/aa/|[115, 35, 0.75]|
   |/r/|[125, 125, 0.85]|
   |/hh/|[130, 50, 0.9]|
   |/ae/|[135, 60, 0.95]|
   |/p/|[140, 40, 1.0]|
   |/iy/|[145, 45, 1.05]|
This vector representation may be integrated with the combination of the phoneme embeddings and speaker embedding described above.

At 210, speech engine 101 executes the vocoder model 124 to generate speech reciting the input word sequence 106. During training, the output waveform generated by vocoder model 124 is compared against a target waveform. Target acoustic features (Mel spectrogram or self-supervised learning features) are constructed from the target waveform.

The acoustic model comprised of the phoneme embedding model used to generate phoneme embedding 108, the speaker embedding model used to generate speaker embedding 110, encoder 116, PCN 118, and decoder 120, is trained to minimize the difference between the predicted acoustic features and the target acoustic features.

Vocoder model 124 is trained to minimize the difference between the predicted waveform and the target waveform.

FIG. 3 is a block diagram illustrating a computer system 20 on which aspects of systems and methods for generating speech with intonation variety using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-2 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for executing a text-to-speech machine learning model, the method comprising:
determining a first phoneme embedding from an input phoneme sequence;
determining, using a text embedding model, a token-level embedding from an input word sequence, wherein the input phoneme sequence corresponds to the input word sequence;
upsampling the token-level embedding into a second phoneme embedding;
inputting both the first phoneme embedding and the second phoneme embedding in an encoder-decoder machine learning model configured to generate acoustic features for a vocoder model that produces a speech waveform; and
executing the vocoder model to generate speech reciting the input word sequence.

2. The method of claim 1, wherein the text embedding model is a transformer-based text embedding model.

3. The method of claim 1, further comprising:
determining a speaker embedding based on an input speaker identifier; and
inputting the speaker embedding into the encoder-decoder machine learning model, wherein a voice associated with the speech generated by the vocoder model is of a speaker associated with the input speaker identifier.

4. The method of claim 1, wherein the encoder-decoder machine learning model is integrated with a prosody conditioning network (PCN).

5. The method of claim 4, wherein the PCN extracts prosodic features from the input word sequence, further comprising:
integrating an output latent representation of an encoder in the encoder-decoder machine learning model with the prosodic features; and
inputting the integrated output latent representation into a decoder of the encoder-decoder machine learning model to generate the acoustic features.

6. The method of claim 5, wherein integration of the output latent representation with the prosodic features is performed using one or more of:
concatenation, addition, a fusion function.

7. The method of claim 5, wherein the prosodic features comprise one or more of: pitch, duration, and energy.

8. The method of claim 1, wherein the acoustic features are comprised in a Mel spectrogram or self-supervised learning features.

9. A system for executing a text-to-speech machine learning model, comprising:
at least one memory; and
at least one hardware processor coupled with the at least one memory and configured, individually or in combination, to:
determine a first phoneme embedding from an input phoneme sequence;
determine, using a text embedding model, a token-level embedding from an input word sequence, wherein the input phoneme sequence corresponds to the input word sequence;
upsample the token-level embedding into a second phoneme embedding;
input both the first phoneme embedding and the second phoneme embedding in an encoder-decoder machine learning model configured to generate acoustic features for a vocoder model that produces a speech waveform; and
execute the vocoder model to generate speech reciting the input word sequence.

10. The system of claim 9, wherein the text embedding model is a transformer-based text embedding model.

11. The system of claim 9, wherein the at least one hardware processor is further configured to:
determine a speaker embedding based on an input speaker identifier; and
input the speaker embedding into the encoder-decoder machine learning model, wherein a voice associated with the speech generated by the vocoder model is of a speaker associated with the input speaker identifier.

12. The system of claim 9, wherein the encoder-decoder machine learning model is integrated with a prosody conditioning network (PCN).

13. The system of claim 12, wherein the PCN extracts prosodic features from the input word sequence, wherein the at least one hardware processor is further configured to:
integrate an output latent representation of an encoder in the encoder-decoder machine learning model with the prosodic features; and
input the integrated output latent representation into a decoder of the encoder-decoder machine learning model to generate the acoustic features.

14. The system of claim 13, wherein integration of the output latent representation with the prosodic features is performed using one or more of:
concatenation, addition, a fusion function.

15. The system of claim 13, wherein the prosodic features comprise one or more of: pitch, duration, and energy.

16. The system of claim 9, wherein the acoustic features are comprised in a Mel spectrogram or self-supervised learning features.

17. A non-transitory computer readable medium storing thereon computer executable instructions for executing a text-to-speech machine learning model, including instructions for:
determining a first phoneme embedding from an input phoneme sequence;
determining, using a text embedding model, a token-level embedding from an input word sequence, wherein the input phoneme sequence corresponds to the input word sequence;
upsampling the token-level embedding into a second phoneme embedding;
inputting both the first phoneme embedding and the second phoneme embedding in an encoder-decoder machine learning model configured to generate acoustic features for a vocoder model that produces a speech waveform; and
executing the vocoder model to generate speech reciting the input word sequence.
